(19) United States
(12) Patent Application Publication
(10) Pub. No.: US 2024/0161460 A1
(43) Pub. Date: May 16, 2024

(54) SELF-SUPERVISED POINT CLOUD ORDERING USING MACHINE LEARNING MODELS

(71) Applicant: Qualcomm Technologies, Inc., San Diego, CA (US)

(72) Inventors: Pengwan YANG, Amsterdam (NL); Yuki Markus ASANO, Amsterdam (NL); Cornelis Gerardus Maria SNOEK, Volendam (NL)

(21) Appl. No.: 18/501,167

(22) Filed: Nov. 3, 2023

Related U.S. Application Data
(60) Provisional application No. 63/383,381, filed on Nov. 11, 2022.

(51) Int. Cl. G06V 10/77; G06V 10/42; G06V 10/764; G06V 10/774; G06V 10/82; G06V 20/70

(52) U.S. Cl. CPC G06V 10/7715; G06V 10/42; G06V 10/764; G06V 10/774; G06V 10/82; G06V 20/70

(57) ABSTRACT

Certain aspects of the present disclosure provide techniques and apparatuses for inferencing against a multidimensional point cloud using a machine learning model. An example method generally includes generating a score for each respective point in a multidimensional point cloud using a scoring neural network. Points in the multidimensional point cloud are ranked based on the generated score for each respective point in the multidimensional point cloud. The top points are selected from the ranked multidimensional point cloud, and one or more actions are taken based on the selected top k points.

### CROSS-REFERENCE TO RELATED APPLICATIONS

This application claims priority to and benefit of U.S. Provisional Patent Application Ser. No. 63/383,381, entitled “Self-Supervised Point Cloud Ordering Using Machine Learning Models,” filed Nov. 11, 2022, and assigned to the assignee hereof, the entire contents of which are hereby incorporated by reference.

### INTRODUCTION

Aspects of the present disclosure relate to machine learning models, and more specifically to generating inferences from multidimensional data using machine learning models.

Machine learning models, such as artificial neural networks (ANNs), convolutional neural networks (CNNs), or the like, can be used to perform various actions on input data. These actions may include, for example, data compression, pattern matching (e.g., for biometric authentication), object detection (e.g., for surveillance applications, autonomous driving, or the like), natural language processing (e.g., identification of keywords in spoken speech that triggers execution of specified operations within a system), or other inference operations in which models are used to predict something about the state of the environment from which input data is received. These models may generally be trained using a source data set which may be different from a target data set which the machine learning models use as input for inferencing. For example, in an example in which machine learning models are trained and deployed for use in object avoidance tasks in autonomous driving, a source data set may include images, video, or other content captured in a specific environment with specific equipment in a specific state (e.g., an urban or otherwise highly built environment, with imaging devices having specific noise and optical properties, that are relatively clean).

In some cases, the input data which a machine learning model uses to generate an inference may include multidimensional data, such as a multidimensional point cloud representing or otherwise illustrating a visual scene. A point cloud representing a visual scene, such as that captured using depth-aware imaging techniques, may include multiple spatial dimensions and may include a large number of discrete points. Because a multidimensional point cloud may include a large number of points, processing a multidimensional point cloud in order to infer meaningful data from the multidimensional point cloud may be a computationally expensive task. Further, many of the points in a point cloud may represent the same or similar data, and thus, processing a multidimensional point cloud may also result in redundant computation for points that have the same, or at least very similar, semantic meanings or similar contributions to the meaning of a multidimensional point cloud.

### BRIEF SUMMARY

Certain aspects provide a processor-implemented method for inferencing against a multidimensional point cloud using a machine learning model. An example method generally includes generating a score for each respective point in a multidimensional point cloud. Points in the multidimensional point cloud are ranked based on the generated score for each respective point in the multidimensional point cloud. The top points are selected from the ranked multidimensional point cloud, and one or more actions are taken based on the selected top points.

Certain aspects provide a processor-implemented method for training a machine learning model to perform inferences from a multidimensional point cloud. An example method generally includes training a neural network to map multidimensional point clouds into feature maps. A score is generated for each respective point in a multidimensional point cloud. The points in the multidimensional point cloud are ranked based on the generated score for each respective point in the multidimensional point cloud. A plurality of top point sets are generated from the ranked points in the multidimensional point cloud. The neural network is retrained based on a noise contrastive estimation loss calculated based on the plurality of top point sets.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain features of various aspects of the present disclosure and are therefore not to be considered limiting of the scope of this disclosure.

FIG. 1 illustrates an example pipeline for training and using a self-supervised machine learning model trained to perform inferences on a multidimensional point cloud, according to aspects of the present disclosure.

FIG. 2 illustrates an example of contrastive learning based on an ordered set of points in a multidimensional point cloud, according to aspects of the present disclosure.

FIG. 3 illustrates example operations for self-supervised training of a machine learning model to perform inferences on a multidimensional point cloud, according to aspects of the present disclosure.

FIG. 4 illustrates example operations for processing a multidimensional point cloud using a self-supervised machine learning model, according to aspects of the present disclosure.

FIG. 5 illustrates an example implementation of a processing system on which self-supervised training of a machine learning model to perform inferences on a multidimensional point cloud can be performed, according to aspects of the present disclosure.

FIG. 6 illustrates an example implementation of a processing system on which processing a multidimensional point cloud using a self-supervised machine learning model can be performed, according to aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide techniques and apparatuses for training and using self-supervised machine learning models to efficiently and accurately process multidimensional point clouds.

Multidimensional data, such as multidimensional point clouds, may provide a significant amount of data about a visual scene. For example, unlike two-dimensional data in which the straight-line distance from a reference point (also known as a datum point), such as the location of an imaging device capturing an image of a scene, to an object in the scene may not be known, multidimensional point clouds may provide information about the three-dimensional spatial location (e.g., height relative to an elevation datum point, lateral (side-to-side) distance relative to a defined datum point, and depth relative to a defined datum point) of each object in a scene relative to the reference point. Thus, such multidimensional data may be useful for various tasks in spatial environments, such as object detection and collision avoidance in autonomous vehicles (self-driving cars) or other autonomous control scenarios (e.g., robotics).

A multidimensional point cloud, however, as discussed above, may include a large amount of data (e.g., a large number of discrete data points) which may be impractical to process in order to extract meaning or other information from the multidimensional point cloud. Further, the points in a multidimensional point cloud may have different levels of importance and contribute different amounts of meaning to the overall scene in which the point cloud exists. For example, two points that are adjacent to each other in a point cloud may convey similar information, as these points may be located on a same surface of an object in a spatial environment; however, two points that are far away from each other in the point cloud may convey very different information (e.g., relate to different objects in a spatial environment or different surfaces of the same object in the spatial environment).

Because processing a point cloud is generally a computationally expensive operation, various techniques can be used to reduce the size of the point cloud from which meaning is to be extracted. For example, random selection or furthest point sampling can be used to reduce the size of a point cloud that is provided as input into a machine learning model for processing. However, random sampling may result in the selection of points in the point cloud that convey significant amounts of information and points in the point cloud that convey minimal information (since, as discussed above, points that are proximate to each other may convey minimal additional information, while points that are far away from each other may relate to different portions of the same object (e.g., a point corresponding to the left wingtip of an aeroplane and a point corresponding to the right wingtip of the aeroplane, or a point corresponding to the bow of a ship and a point corresponding to the stern of the ship, both of which may have a distance of a sizable number of meters from each other) or may relate to different objects altogether). Thus inference performance using a randomly selected or sampled subset of points from a point cloud may be negatively impacted. Other techniques may attempt to order the points in a point cloud. For example, group-wise ordering can be achieved using fully supervised models; however, these techniques may not differentiate between different discrete points in the point cloud and may entail the use of labeled data (which may be unavailable or impractical to generate) for supervised learning. Another technique may allow for point-wise projection of a point cloud; however, these techniques may not allow for an ordering to be directly learned from an input point cloud, but rather involve various transformations and projections—and thus additional computational expense—before the points in a point cloud can be ordered.

Aspects of the present disclosure provide techniques and apparatuses for efficiently ordering points in multidimensional point clouds to allow for the identification and use of a representative subset of points to perform an inference on the multidimensional point cloud. As discussed in further detail below, a scoring neural network can be used to assign a score to each point in a multidimensional point cloud. The score assigned to a point may indicate a relative importance of that point to the overall meaning of the multidimensional point cloud. The points may be sorted by score, and the top k points can be used to perform inferences on the multidimensional point cloud using a machine learning model and to perform self-supervised training of a machine learning model that maps input multidimensional point clouds to a feature map based on which the scores for each point can be generated. By using scoring and top-k selection techniques on points in a multidimensional point cloud, a representative subset of points from the multidimensional point cloud can be selected for use in further operations, which may allow for inferences to be performed using fewer compute resources (e.g., processor time, memory, etc.) while maintaining inference accuracy, relative to other techniques for performing inferences on a multidimensional point cloud.

### Example Self-Supervised Point Cloud Ordering Using Machine Learning Models

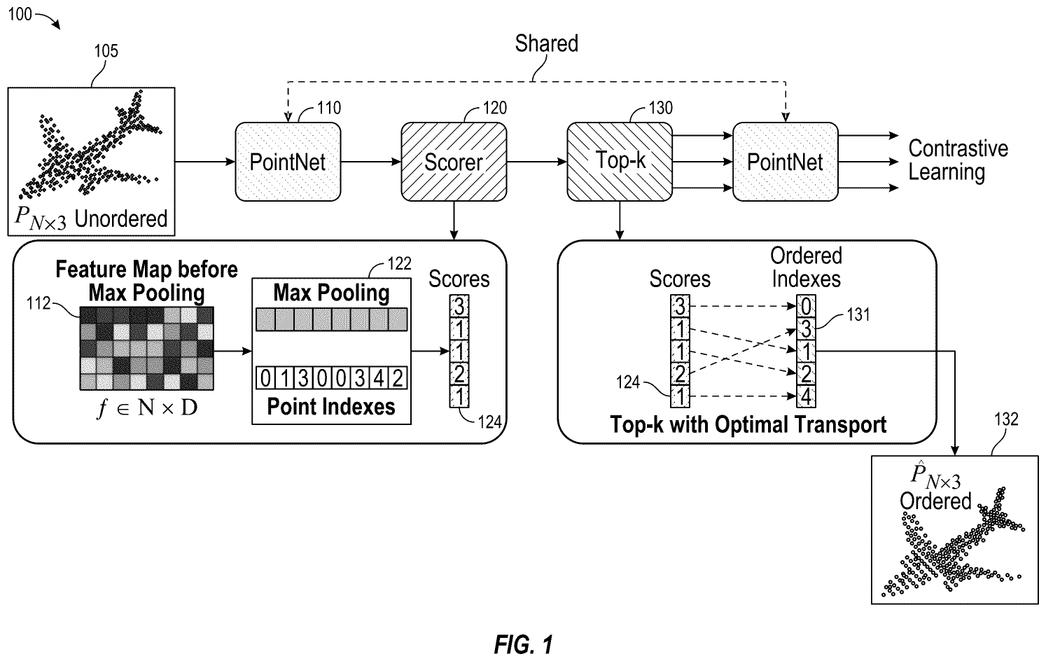

FIG. 1 depicts an example pipeline 100 for training and using a self-supervised machine learning model to perform inferences on a multidimensional point cloud, according to aspects of the present disclosure.

Pipeline 100, as illustrated, includes a point network 110 (labeled “PointNet”), a scoring neural network 120 (labeled “Scorer”), and a top point selection module 130 (labeled “Top-k”). Pipeline 100 may be configured to order points in an input multidimensional point cloud, such as multidimensional point cloud P 105, using self-supervised machine learning techniques. Multidimensional point cloud P 105 may be represented as P={pᵢ}ᵢ₌₁^{N} with pᵢ ∈ [symbol] , where pᵢ represents the i^{th} point in the multidimensional point cloud P 105 and N corresponds to the number of points in the multidimensional point cloud P 105. As illustrated, each of the N points in the multidimensional point cloud 105 may be associated with a real value in each of a plurality of dimensions (e.g., in this example, three spatial dimensions, such as height, width, and depth). Pipeline 100 may attempt to find an ordering of the points γ*=(i₁, i₂, . . . , iₙ) from an unlabeled data set that minimizes, or at least reduces, the value of the downstream objective function ϕ:

$${γ}^{*} = arg {min}_{γ} ϕ ( {S}_{n} )$$

where various subsets of Sₙ={pᵢ_{ₖ}}ₖ₌₁ⁿ contain the top n points, where n≤N.

To identify an ordering of the points in multidimensional point cloud 105 such that the highest ranked points correspond to the points that make the most meaningful contributions to the meaning of multidimensional point cloud 105, the point network 110 can generate a feature map [symbol] 112 from the multidimensional point cloud 105. The point network 110 may generate the feature map [symbol] 112 with dimensions of N×D, where N represents the number of points in multidimensional point cloud 105 and D represents the number of dimensions in the feature map [symbol] 112 into which multidimensional point cloud P 105 is mapped. D may be different from the number of dimensions in which points in the multidimensional point cloud lie. In some aspects, point network 110 may be a neural network (a feature extracting neural network) or other machine learning model that takes a set of unordered points in a point cloud as an input and generates the feature map as the output of a plurality of multi-layer perceptrons (MLPs). Point network 110 may, in some aspects, exclude transformation layers which may be used to apply various geometric transformations to the multidimensional point cloud 105 to allow for point network 110 to be spatially invariant.

Scoring neural network 120 may be a neural network configured to generate a score for each point in the point cloud based on the feature map [symbol] 112 generated by point network 110. Generally, scoring neural network 120 may provide a mapping ƒ from a point cloud to a score vector according to the expression ƒ: P→ [symbol] . In doing so, given a feature map [symbol] ∈ [symbol] 112, scoring neural network 120 computes a score matrix 124 including a score for each point in the multidimensional point cloud P 105. Generally, the score matrix 124 may be ordered based on an index associated with each point in the feature map [symbol] 112 such that the score matrix 124 is unordered with respect to the scores generated for each point in the feature map [symbol] 112. A feature for the i^{th} point in the feature map [symbol] may be denoted as [symbol] ᵢ={ƒᵢ₁, ƒᵢ₂, . . . , ƒ_{iD}} in D dimensions, and ƒᵢⱼ, j ∈ {1,2, . . . , N} represents the ij^{th} element in [symbol] ᵢ.

Generally the score generated for the i^{th} point in the multidimensional point cloud P 105 may be computed to represent the contribution of that point to a global feature [symbol] representing multidimensional point cloud P 105. The global feature [symbol] ={g₁, g₂, . . . , g_{D}} may be computed by an order-invariant max-pooling block 122 represented by the equation:

$${g}_{j} = {max}_{i = 1 , 2 , … , N} {f}_{ij} , for j ∈ \{ 1 , 2 , … , D \}$$

or, alternatively (and equivalently):

[symbol]

=maxpool( [symbol] , dim=0)

A point having the maximum value in the j^{th} dimension may be calculated according to the equation:

$${idx}_{j} = arg {max}_{i = 1 , 2 , … , N} {f}_{ij} for j ∈ \{ 1 , 2 , … , D \}$$

In some aspects, to compute the importance of a point i to the global feature [symbol] , the number of times the feature [symbol] ᵢ appears in the global feature [symbol] may be computed. Thus, a score sᵢ for a point i may be calculated according to the equation:

$${s}_{i} = \frac{1}{D} {\sum }_{j = 1}^{D} {δ}_{{idx}_{j} , i}$$

where δ_{xy} represents a Kronecker delta function where δ_{xy}=0 if x≠y and δ_{xy}=1 if x=y. The score sᵢ for a point i may be 1.0 if the feature [symbol] ᵢ for that point i is descriptive of the global feature [symbol] in its entirety and may be 0.0 if the feature [symbol] ᵢ for that point i is not descriptive of the global feature [symbol] .

However, to allow for contrastive learning to be performed by backpropagating a noise contrastive estimation (NCE) loss through point network 110 (as discussed in further detail below), the score sᵢ may be represented as a differentiable approximation of the importance of features [symbol] ᵢ for a point i. The differentiable approximation may be represented by the equation:

$${s}_{i} = \frac{1}{D} {\sum }_{j = 1}^{D} 2 \cdot σ ( {f}_{ij} - {g}_{j} )$$

where σ represents a sigmoid operation with temperature τ such that

$$σ ( x ) = \frac{1}{1 + {e}^{- x / τ}} .$$

By scaling σ with 2, the sigmoid outputs may arrive at the interval [0, 1]. Like the score generated based on the Kronecker delta function discussed above, the score sᵢ for a point i may be 1.0 if the feature [symbol] ᵢ for that point i is descriptive of the global feature [symbol] in its entirety and may be 0.0 if the feature [symbol] ᵢ for that point i is not descriptive of the global feature [symbol] . Further, because sᵢ ∝ Σⱼ(σ(ƒᵢⱼ−gⱼ)), the score vector [symbol] for all points may be represented by the equation [symbol] =sum(σ( [symbol] − [symbol] ), dim=1).

While the scoring neural network 120 is discussed above with respect to a sigmoid function, it should be recognized that other non-linear functions can be used to generate a score for each point i in feature map [symbol] . For example, these non-linear functions may include functions such as the hyperbolic tangent (tanh) function or the like.

Top point selection module 130 is generally configured to sort, in a differentiable manner, the points in multidimensional point cloud P 105 based on the score matrix 124 including scores generated for points in multidimensional point cloud P 105 by scoring neural network 120. In doing so, top point selection module 130 may use a top-k operator that ranks the points in the multidimensional point cloud P 105 by solving a parameterized optimal transport problem, for example. Generally, the optimal transport problem attempts to find a transport plan from a discrete distribution [symbol] =[s₁, s₂, . . . , sₙ]^{T} to a discrete distribution [symbol] =[0,1,2, . . . , N−1]^{T}.

To identify the transport plan from [symbol] to [symbol] , marginals for both [symbol] and [symbol] may be defined as μ=ν=1_{N}/N, and a cost matrix C ∈ [symbol] may be defined, with Cᵢⱼ representing the cost of transporting mass from sᵢ to bⱼ (e.g., from the i^{th} point to the j^{th} element in [symbol] . The cost may be, for example, defined as the squared Euclidean distance between sᵢ and bⱼ such that Cᵢⱼ=(sᵢ−(j−1))².

Given the marginals μ for [symbol] and [symbol] and the cost matrix C, the optimal transport problem can be represented by the equation:

$${Γ}^{*} = arg {min}_{Γ \geq 0} ( C , Γ 〉 + ϵ h ( Γ ) ,$$

such that Γ1_{N}=μ and Γ^{T} 1_{N}=ν, where [symbol] · [symbol] represents the inner product and h(Γ)=Σᵢⱼ Γᵢⱼ log Γᵢⱼ represents an entropy regularizer that can minimize, or at least reduce, discontinuities and generate a smoothed and differentiable approximation for the top-k operation. An approximation Γ* of the optimal Γ may thus represent the optimal transport plan that transforms discrete distribution [symbol] to discrete distribution [symbol] . The approximate optimal transport plan Γ* may be scaled by N so that γ*=NΓ*· [symbol] represents the ordering of the points in multidimensional point cloud P 105, represented as sorted point cloud \hat{P} 132, where \hat{P} ∈ [symbol] . In some aspects, the sorted point cloud \hat{P} 132 may be represented by an ordered vector 131. The ordered vector 131 may be generated by sorting the score matrix 124 from the highest score to the lowest score, such that the index of a point in the ordered vector 131 is different from the index of that point in the feature map [symbol] 112 (or a max-pooled version thereof). In the sorted point cloud \hat{P} 132, the point with the highest score may be set to 0, the point with the next highest score may be set to 1, and so on, until the point with the lowest score is set to N−1.

After generating the sorted point cloud \hat{P} 132, top point selection module 130 can generate one or more point sets from \hat{P} 132. These one or more point sets can be used as input into another machine learning model to perform various tasks, such as semantic segmentation of an input image into a plurality of segments corresponding to different types of objects in the image, classification of an input represented by the multidimensional point cloud 105 as representative of one of a plurality of types of objects, or the like.

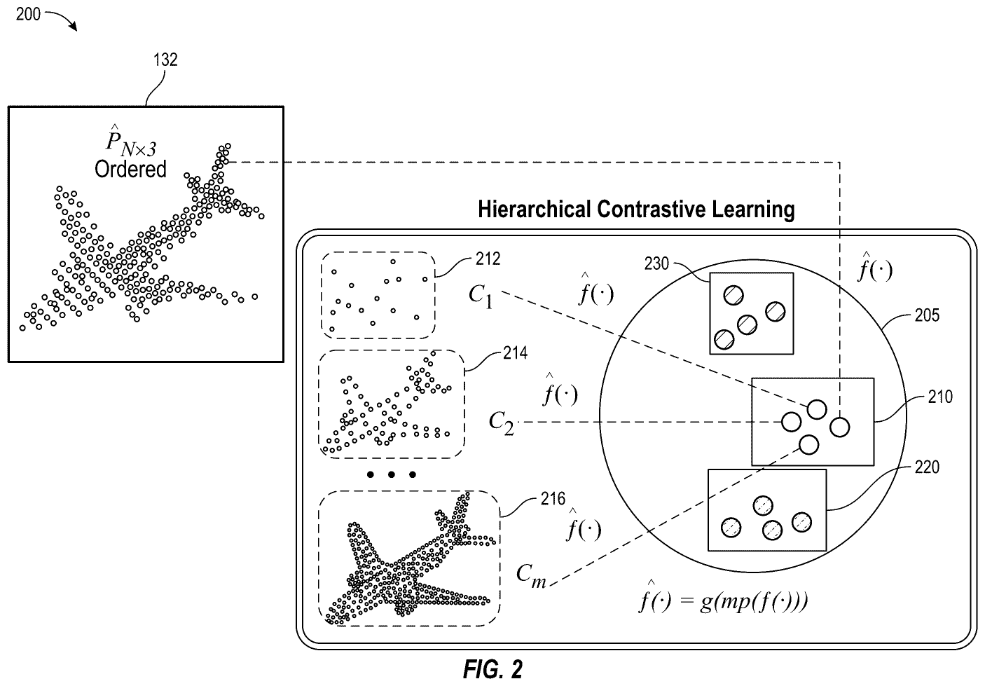

FIG. 2 illustrates an example 200 of contrastive learning based on an ordered set of points in a multidimensional point cloud, according to aspects of the present disclosure.

In some aspects, the point network 110 may be retrained, or refined, using self-supervision techniques. In such a case, the hierarchical scheme (e.g., the order in which points are sorted in \hat{P} 132) may be used as a supervision signal for retraining the point network 110. To retrain the point network 110, a plurality of subsets of points in multidimensional point cloud P 105 can be generated. The subsets of points [symbol] may be defined with increasing cardinality, represented as [symbol] ={cₖ}ₖ₌₁^{m}, with |cₖ|=δ^{k}, m=log_{δ}(N), and ∀k: cₖ⊂cₖ₊₁, δ is a growth factor, and k corresponds to an index. In determining the size of each subset c of points from multidimensional point cloud P 105, the δ term may control, or at least influence, the growth of the size of each subset c. For example, in an exponential growth scheme, the first subset c₁ may include the top δ points in the ranked multidimensional point cloud 105, the second subset c₂ may include the top δ² points, the third subset c₃ may include the top δ³ points, and so on.

To train or re-train the point network 110, the subsets of points [symbol] from \hat{P} 132 may be treated as positive pairs for use in calculating an NCE loss, while negative pairs may be constructed from subsets of points from point clouds different from the multidimensional point cloud 105 (e.g., point clouds representing other objects or other scenes different from the object or scene depicted by the multidimensional point cloud 105, such as the points in the point set which are projected into regions 220 or 230 of the latent space 205). Using the positive pairs from [symbol] and negative pairs from other point clouds in the point sets 220 and 230 (amongst others, not illustrated in FIG. 2), a multiple-instance NCE loss may be represented by the equation:

$${ℒ}_{NCE}^{{c}_{k}} ( \hat{P} ) = - log \frac{{\sum }_{{c}_{k}^{+}} exp ( \frac{〈 \hat{f} ( \hat{P} ) , \hat{f} ( c ) 〉}{φ} )}{{\sum }_{{c}_{k}^{+} ⋃ {c}_{k}^{-}} exp ( \frac{〈 \hat{f} ( \hat{P} ) , \hat{f} ( c ) 〉}{φ} )}$$

where cₖ⁺ represents the positive set and cₖ⁻ represents the negative set for the i^{th} subset of points from \hat{P} 132. In the above equation, \hat{ƒ}(·)=g(mp(ƒ(·)) represents a procedure including the backbone ƒ of scoring neural network 120, a max-pooling operation mp, and a projection head g configured to project the pooled features of point subsets into a shared latent space 205. That is, to train or retrain the point network 110, the subsets of points [symbol] may be projected into a latent space representation, with these points being projected into a first region 210 of the latent space 205. Each set of points c 212, 214, 216 may represent different subsets of points from the multidimensional point cloud P 105, with the first set c₁ 212 being the smallest set and being a subset of the second set c₂ 214, which in turn may be smaller than and a subset of the m^{th} set cₘ 216 (as well as any intervening sets of points, not illustrated in FIG. 2, between c₂ 214 and cₘ 216). Meanwhile, as discussed, the other point sets based on which contrastive learning is to be performed on the point network 110 may be projected into other regions in the latent space 205, such as regions 220 and 230 (amongst others).

The overall loss function used for training (or retraining) the point network 110 using contrastive learning techniques may be represented by the equation:

$$ℒ ( \hat{P} ) = {\sum }_{k = 1}^{m} {ℒ}_{NCE}^{{c}_{k}} ( \hat{P} )$$

Because the subsets of points [symbol] increase in cardinality, the top points may be used more often in calculating the contrastive loss between different subsets of points, as these top points may be shared across different subsets of points. Thus, the importance of these top points may be scaled for the total loss, and the pipeline 100 illustrated in FIG. 1 may generate scores that allow for the most contrastively informative points to be ranked at or near the top of the ranked set of points generated by top point selection module 130 illustrated in FIG. 1.

### Example Self-Supervised Point Cloud Ordering Using Machine Learning Models

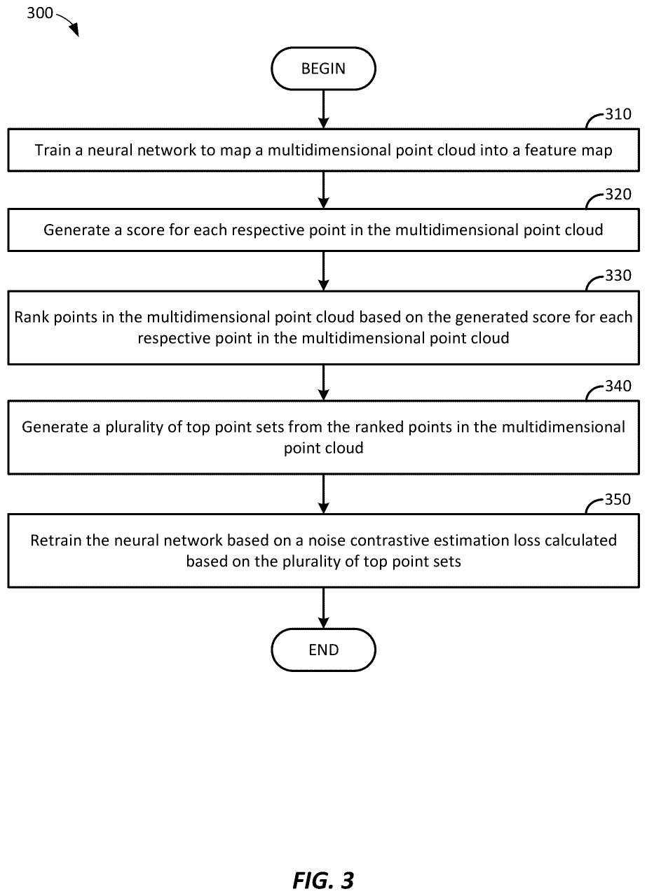

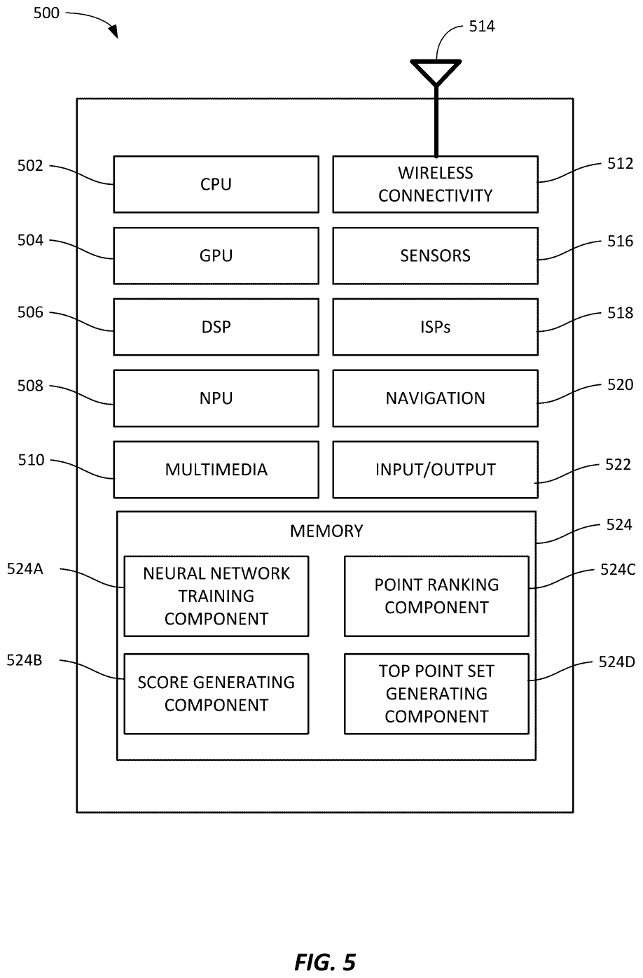

FIG. 3 illustrates example operations 300 for self-supervised training of a machine learning model to perform inferences on a multidimensional point cloud, according to aspects of the present disclosure. Operations 300 can be performed, for example, by a computing system, such as that illustrated in FIG. 5, on which training data sets of multidimensional point clouds can be used to train a machine learning model to identify a representative set of points for a multidimensional point cloud and perform inferences based on the representative set of points.

As illustrated, operations 300 may begin at block 310, in which a neural network is trained to map a multidimensional point cloud into a feature map using a feature generating neural network (e.g., the point network 110 illustrated in FIG. 1). As discussed, the multidimensional point cloud may have N points, with each point being located in a multidimensional (e.g., three-dimensional) space. Each point in the multidimensional point cloud generally represents spatial data in each dimension of a multidimensional space in which the data from which the multidimensional point cloud was generated lies. In some aspects, where the multidimensional point cloud includes spatial data, such spatial data may be measured or otherwise represented relative to one or more reference points or planes. In some aspects, one or more dimensions in which data is located in the multidimensional point cloud may be non-spatial dimensions, such as frequency dimensions, temporal dimensions, or the like.

At block 320, operations 300 proceed with generating a score for each respective point in the multidimensional point cloud using a point scoring neural network (e.g., the scoring neural network 120 illustrated in FIG. 1). As discussed, the score generated for each respective point in the multidimensional point cloud may be a score relative to an overall feature into which the multidimensional point cloud is mapped by the feature generating neural network. Points having higher scores may correspond to points having a higher degree of importance to the overall feature into which the multidimensional point cloud is mapped and may have higher scores than points which have a lesser degree of importance to the overall feature into which the multidimensional point cloud is mapped. In some aspects, the score for a respective point in the multidimensional point cloud may be calculated based on the sum of a max-pooled set of features calculated along each feature dimension for that point.

At block 330, operations 300 proceed with ranking points in the multidimensional point cloud based on the generated score for each respective point in the multidimensional point cloud. To rank the points in the multidimensional point cloud, an optimum transport problem can be solved in order to map a discrete distribution [symbol] of points to a discrete, ordered distribution [symbol] . The resulting ranked set of points \hat{P} may include the same number of points as the input multidimensional point cloud P, with values from 0 through N−1. The value 0 may be assigned to the point having the highest score, the value 1 may be assigned to the point having the next highest score, and so on, with the point having the lowest score being assigned the value N−1.

At block 340, operations 300 proceed with generating a plurality of top point sets from the ranked points in the multidimensional point cloud. The plurality of top point sets, in some aspects, may be generated with increasing cardinality based on a base size (e.g., the growth factor term δ) associated with the first (smallest) top point set of the plurality of top point sets. For example, the top point sets may increase in size exponentially, such that for the k^{th} point set, the size of (e.g., number of points included in) the k^{th} point set is represented by δ^{k-1}.

At block 350, operations 300 proceed with retraining the neural network based on a noise contrastive estimation loss (e g , minimizing such a loss) calculated based on the plurality of top point sets. To do so, an NCE loss may be calculated between the plurality of top point sets, treated as a positive set, and top point sets from one or more other multidimensional point clouds, treated as a negative set. In some aspects, the NCE loss may be calculated based on a projection of features of the point subsets in the positive and negative sets into a shared latent space. Generally, because the subsets of points may increase in cardinality (e.g., size), the top points may be used more often in calculating the NCE loss, and the neural network may be trained to generate the highest scores for the points in the multidimensional point cloud that are the most contrastively informative points and generate lower scores for points in the multidimensional point cloud that are less contrastively informative.

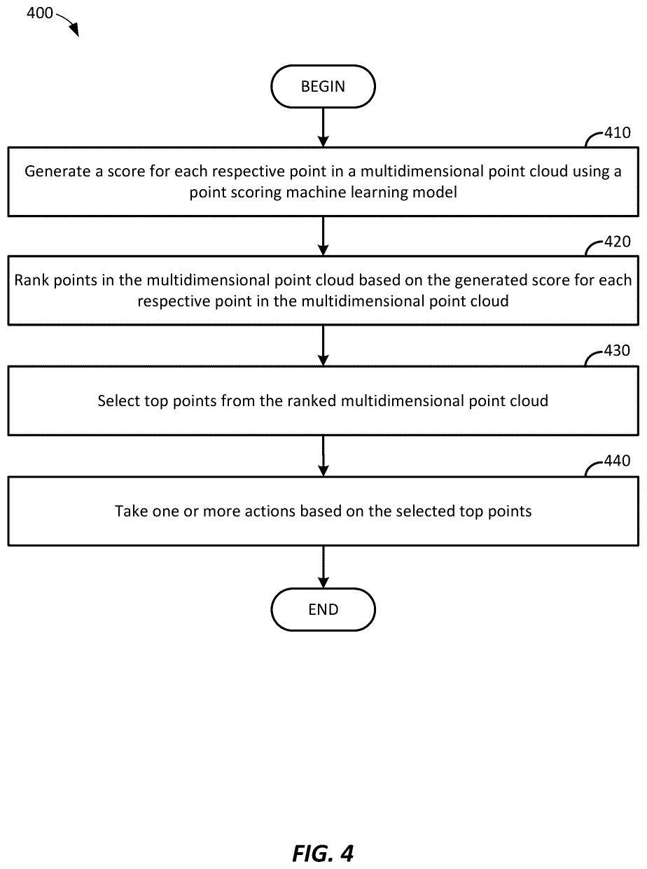

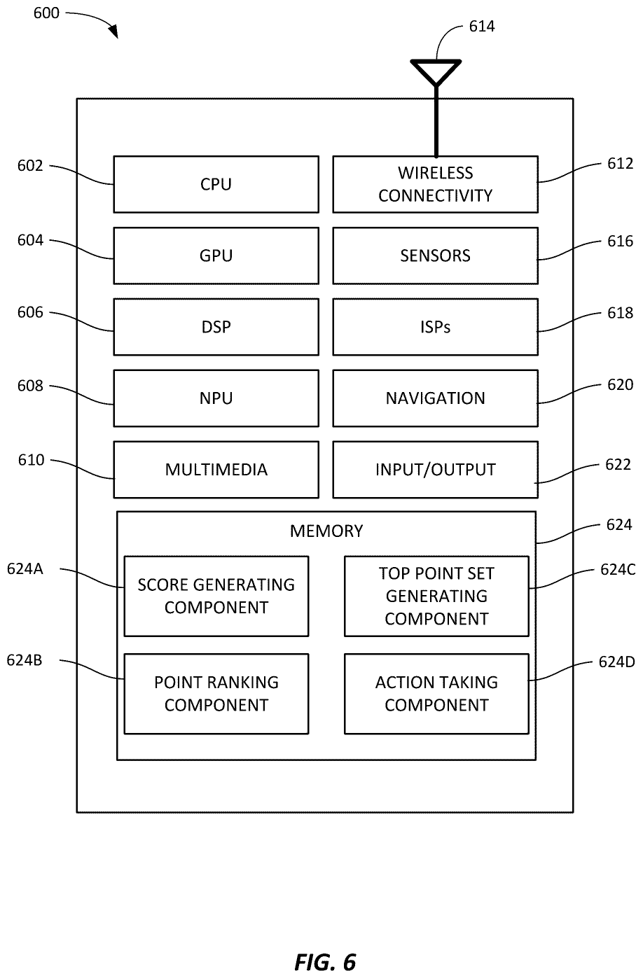

FIG. 4 illustrates example operations 400 for processing a multidimensional point cloud using a self-supervised machine learning model, according to aspects of the present disclosure. Operations 400 can be performed, for example, by a computing system, such as a user equipment (UE) or other computing device, such as that illustrated in FIG. 6, on which a trained machine learning model can be deployed and used to process an input multidimensional point cloud.

As illustrated, operations 400 begin at block 410, with generating a score for each respective point in a multidimensional point cloud.

In some aspects, the operations further include generating the multidimensional point cloud based on a neural network that is trained to generate a feature map based on the input of a multidimensional point cloud representing an object or scene input into a neural network for analysis. In some aspects, the multidimensional point cloud may be generated based on one or more ranging devices associated with the UE or other computing device performing the operations 400. For example, in an autonomous vehicle deployment, these ranging devices may include radar devices, LIDAR sensors, ultrasonic sensors, or other devices that are capable of measuring a distance between the ranging device and another object.

In some aspects, the multidimensional point cloud may include a set of points having a plurality of spatial dimensions. Generally, points in the multidimensional point cloud may have values determined in relation to one or more reference points or planes For example, in a visual scene, the set of points may include data on the height, width, and depth dimensions, with the height data being relative to a defined reference zero-elevation plane, width being relative to a datum point such as the center of an imaging device that captured the image from which the multidimensional point cloud was generated or some other reference point, and depth being relative to a datum point such as the point at which the imaging device is located. In some aspects, the multidimensional point cloud may also or alternatively include points having one or more non-spatial dimensions, such as a frequency dimension, a temporal dimension, or the like.

In some aspects, to generate a score for each respective point in the multidimensional point cloud, the multidimensional point cloud may be mapped into a feature map representative of the multidimensional point cloud using a point network. The point network, in some aspects, may map the multidimensional point cloud into the feature map based on a self-supervised loss function trained to map points in a multidimensional space to features in a multidimensional feature space.

In some aspects, for a multidimensional point cloud having N points, the point network may generate a two-dimensional matrix with dimensions of N by D, where D represents the number of feature dimensions into which points are mapped. That is, each point i, i ∈ N, may be associated with D feature values in the feature map. The score for each respective point i may be calculated based on the feature map representing the multidimensional point cloud.

In some aspects, the score generated for each respective point in the multidimensional point cloud may be a score relative to an overall feature into which the multidimensional point cloud is mapped by the neural network. Points having higher scores may correspond to points having a higher degree of importance to the overall feature into which the multidimensional point cloud is mapped and may have higher scores than points which have a lesser degree of importance to the overall feature into which the multidimensional point cloud is mapped. In some aspects, the score for a respective point in the multidimensional point cloud may be calculated based on the sum of a max-pooled set of features calculated along each feature dimension for that point.

At block 420, operations 400 proceed with ranking points in the multidimensional point cloud based on the generated score for each respective point in the multidimensional point cloud. In some aspects, to rank the points in the multidimensional point cloud, an optimum transport problem can be solved in order to map a discrete distribution [symbol] of points to a discrete, ordered distribution [symbol] . The resulting ranked set of points \hat{P} may include the same number of points as the input multidimensional point cloud P, with values from 0 through N−1. The value 0 may be assigned to the point having the highest score, the value 1 may be assigned to the point having the next highest score, and so on, with the point having the lowest score being assigned the value N−1.

At block 430, operations 400 proceed with selecting top points rom the ranked multidimensional point cloud. In some aspects, the top points may be the top k points selected based on noise contrastive estimation over a plurality of subsets of multidimensional point clouds.

At block 440, operations 400 proceed with taking one or more actions based on the selected top points. In some aspects, the one or more actions may include classifying an input represented by the multidimensional point cloud as representative of one of a plurality of types of objects. In some aspects, the one or more actions may include semantically segmenting an input image into a plurality of segments. Each segment in the plurality of segments may correspond to a type of object in the input image.

### Example Processing System for Adapting Machine Learning Models to Domain-Shifted Data

FIG. 5 depicts an example processing system 500 for self-supervised training of machine learning models to perform inferences on a multidimensional point cloud, such as described herein for example with respect to FIG. 3.

Processing system 500 includes a central processing unit (CPU) 502, which in some examples may be a multi-core CPU. Instructions executed at the CPU 502 may be loaded, for example, from a program memory associated with the CPU 502 or may be loaded from a memory 524.

Processing system 500 also includes additional processing components tailored to specific functions, such as a graphics processing unit (GPU) 504, a digital signal processor (DSP) 506, a neural processing unit (NPU) 508, a multimedia processing unit 510, and a wireless connectivity component 512.

An NPU, such as NPU 508, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPUs), neural network processor (NNP), intelligence processing unit (IPU), vision processing unit (VPU), or graph processing unit.

NPUs, such as NPU 508, are configured to accelerate the performance of common machine learning tasks, such as image classification, machine translation, object detection, and various other predictive models. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this data piece through an already trained model to generate a model output (e.g., an inference).

In some implementations, NPU 508 is a part of one or more of CPU 502, GPU 504, and/or DSP 506.

In some examples, wireless connectivity component 512 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. Wireless connectivity component 512 is further coupled to one or more antennas 514.

Processing system 500 may also include one or more sensor processing units 516 associated with any manner of sensor, one or more image signal processors (ISPs) 518 associated with any manner of image sensor, and/or a navigation processor 520, which may include satellite-based positioning system components (e.g., GPS or GLONASS) as well as inertial positioning system components.

Processing system 500 may also include one or more input and/or output devices 522, such as screens, touch-sensitive surfaces (including touch-sensitive displays), physical buttons, speakers, microphones, and the like.

In some examples, one or more of the processors of processing system 500 may be based on an ARM or RISC-V instruction set.

Processing system 500 also includes memory 524, which is representative of one or more static and/or dynamic memories, such as a dynamic random access memory, a flash-based static memory, and the like. In this example, memory 524 includes computer-executable components, which may be executed by one or more of the aforementioned processors of processing system 500.

In particular, in this example, memory 524 includes neural network training component 524A, score generating component 524B, point ranking component 524C, and top point set generating component 524D. The depicted components, and others not depicted, may be configured to perform various aspects of the methods described herein.

Generally, processing system 500 and/or components thereof may be configured to perform the methods described herein.

Notably, in other aspects, aspects of processing system 500 may be omitted, such as where processing system 500 is a server computer or the like. For example, multimedia processing unit 510, wireless connectivity component 512, sensor processing units 516, ISPs 518, and/or navigation processor 520 may be omitted in other aspects. Further, aspects of processing system 500 may be distributed, such as training a model and using the model to generate inferences.

FIG. 6 depicts an example processing system 600 for processing a multidimensional point cloud using a self-supervised machine learning model, such as described herein for example with respect to FIG. 4.

The processing system 600 includes a central processing unit (CPU) 602, which in some examples may be a multi-core CPU. The processing system 600 also includes additional processing components tailored to specific functions, such as a graphics processing unit (GPU) 604, a digital signal processor (DSP) 606, and a neural processing unit (NPU) 608. The CPU 602, GPU 604, DSP 606, and NPU 608 may be similar to the CPU 502, GPU 504, DSP 506, and NPU 508 discussed above with respect to FIG. 5.

In some examples, wireless connectivity component 612 may include subcomponents, for example, for 3G connectivity, 4G connectivity (e.g., LTE), 5G connectivity (e.g., NR), Wi-Fi connectivity, Bluetooth connectivity, and other wireless data transmission standards. Wireless connectivity component 612 is further coupled to one or more antennas 614.

Processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS) as well as inertial positioning system components.

Processing system 600 may also include one or more input and/or output devices 622, such as screens, touch-sensitive surfaces (including touch-sensitive displays), physical buttons, speakers, microphones, and the like.

In some examples, one or more of the processors of processing system 600 may be based on an ARM or RISC-V instruction set.

Processing system 600 also includes memory 624, which is representative of one or more static and/or dynamic memories, such as a dynamic random access memory, a flash-based static memory, and the like. In this example, memory 624 includes computer-executable components, which may be executed by one or more of the aforementioned processors of processing system 600.

In particular, in this example, memory 624 includes score generating component 624A, point ranking component 624B, top point selecting component 624C, and action taking component 624D. The depicted components, and others not depicted, may be configured to perform various aspects of the methods described herein.

Generally, processing system 600 and/or components thereof may be configured to perform the methods described herein.

Notably, in other aspects, aspects of processing system 600 may be omitted, such as where processing system 600 is a server computer or the like. For example, multimedia processing unit 610, wireless connectivity component 612, sensor processing units 616, ISPs 618, and/or navigation processor 620 may be omitted in other aspects. Further, aspects of processing system 600 may be distributed, such as training a model and using the model to generate inferences.

### Example Clauses

Implementation details of various aspects of the present disclosure are described in the following numbered clauses.

Clause 1: A processor-implemented method, comprising: generating a score for each respective point in a multidimensional point cloud using a scoring neural network; ranking points in the multidimensional point cloud based on the generated score for each respective point in the multidimensional point cloud; selecting top points from the ranked multidimensional point cloud; and taking one or more actions based on the selected top points.

Clause 2: The method of clause 1, wherein generating the score for each point in the multidimensional point cloud comprises: mapping the multidimensional point cloud into a feature map representing the multidimensional point cloud using a feature extracting neural network; and generating the score for each respective point in the multidimensional point cloud based on the feature map representing the multidimensional point cloud.

Clause 3: The method of clause 2, wherein the feature extracting neural network is configured to map the multidimensional point cloud into the feature map based on a self-supervised loss function trained to map points in a multidimensional space to points in a multidimensional feature space.

Clause 4: The method of clause 2 or 3, wherein the feature map comprises a map with dimensions of a number of points in the multidimensional point cloud by a number of feature dimensions into which the multidimensional point cloud is mapped.

Clause 5: The method of any of clauses 2 through 4, wherein the score for each respective point in the multidimensional point cloud is generated based on a global feature representing the multidimensional point cloud and a sum of scores for the respective point in each feature dimension in the feature map.

Clause 6: The method of any of clauses 1 through 5, wherein ranking the points in the multidimensional point cloud comprises ranking the points in the multidimensional point cloud based on optimal transport problem between an unordered ranking of points in the multidimensional point cloud to an ordered ranking of points in the multidimensional point cloud.

Clause 7: The method of any of clauses 1 through 6, wherein selecting the top points from the ranked multidimensional point cloud comprises selecting the top k points based on noise contrastive estimation over a plurality of subsets of multidimensional point clouds.

Clause 8: The method of any of clauses 1 through 7, wherein the one or more actions comprises classifying an input represented by the multidimensional point cloud as representative of one of a plurality of types of objects.

Clause 9: The method of any of clauses 1 through 8, wherein the one or more actions comprise semantically segmenting an input image into a plurality of segments, each segment of the plurality of segments corresponding to a type of object in the input image.

Clause 10: The method of any of clauses 1 through 9, wherein the multidimensional point cloud comprises a set of points having a plurality of spatial dimensions.

Clause 11: A processor-implemented method, comprising: training a neural network to map multidimensional point clouds into feature maps; generating a score for each respective point in a multidimensional point cloud; ranking points in the multidimensional point cloud based on the generated score for each respective point in the multidimensional point cloud; generating a plurality of top point sets from the ranked points in the multidimensional point cloud; and retraining the neural network based on a noise contrastive estimation loss calculated based on the plurality of top point sets.

Clause 12: The method of clause 11, wherein generating the plurality of top point sets from the ranked points in the multidimensional point cloud comprises generating a plurality of top point sets with increasing cardinality based on a base size of a first top point set of the plurality of top point sets.

Clause 13: The method of clause 12, wherein the increasing cardinality is based on exponential growth of the base size.

Clause 14: The method of clause 12 or 13, wherein a k^{th} point set from the plurality of top point sets comprises a subset of a k+1^{th} point set from the plurality of top point sets.

Clause 15: The method of any of clauses 11 through 14, wherein retraining the neural network comprises calculating a noise contrastive estimation loss between the plurality of top point sets and a plurality of point sets from one or more other multidimensional point clouds.

Clause 16: A processing system comprising: a memory comprising computer-executable instructions; and one or more processors configured to execute the computer-executable instructions and cause the processing system to perform a method in accordance with any of clauses 1-15.

Clause 17: A processing system, comprising means for performing a method in accordance with any of clauses 1-15.

Clause 18: A non-transitory computer-readable medium comprising computer-executable instructions that, when executed by one or more processors of a processing system, cause the processing system to perform a method in accordance with any of clauses 1-15.

Clause 19: A computer program product embodied on a computer-readable storage medium comprising code for performing a method in accordance with any of clauses 1-15.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method, comprising:
generating a score for each respective point in a multidimensional point cloud using a scoring neural network;
ranking points in the multidimensional point cloud based on the generated score for each respective point in the multidimensional point cloud;
selecting top points from the ranked multidimensional point cloud; and
taking one or more actions based on the selected top points.

2. The method of claim 1, wherein generating the score for each point in the multidimensional point cloud comprises:
mapping the multidimensional point cloud into a feature map representing the multidimensional point cloud using a feature extracting neural network; and
generating the score for each respective point in the multidimensional point cloud based on the feature map representing the multidimensional point cloud.

3. The method of claim 2, wherein the feature extracting neural network is configured to map the multidimensional point cloud into the feature map based on a self-supervised loss function trained to map points in a multidimensional space to points in a multidimensional feature space.

4. The method of claim 2, wherein the feature map comprises a map with dimensions of a number of points in the multidimensional point cloud by a number of feature dimensions into which the multidimensional point cloud is mapped.

5. The method of claim 2, wherein the score for each respective point in the multidimensional point cloud is generated based on a global feature representing the multidimensional point cloud and a sum of scores for the respective point in each feature dimension in the feature map.

6. The method of claim 1, wherein ranking the points in the multidimensional point cloud comprises ranking the points in the multidimensional point cloud based on an optimal transport problem between an unordered ranking of points in the multidimensional point cloud to an ordered ranking of points in the multidimensional point cloud.

7. The method of claim 1, wherein selecting the top points from the ranked multidimensional point cloud comprises selecting top k points based on noise contrastive estimation over a plurality of subsets of multidimensional point clouds.

8. The method of claim 1, wherein the one or more actions comprise classifying an input represented by the multidimensional point cloud as representative of one of a plurality of types of objects.

9. The method of claim 1, wherein the one or more actions comprise semantically segmenting an input image into a plurality of segments, each segment of the plurality of segments corresponding to a type of object in the input image.

10. The method of claim 1, wherein the multidimensional point cloud comprises a set of points having a plurality of spatial dimensions.

11. A processor-implemented method, comprising:
training a neural network to map multidimensional point clouds into feature maps;
generating a score for each respective point in a multidimensional point cloud;
ranking points in the multidimensional point cloud based on the generated score for each respective point in the multidimensional point cloud;
generating a plurality of top point sets from the ranked points in the multidimensional point cloud; and
retraining the neural network based on a noise contrastive estimation loss calculated based on the plurality of top point sets.

12. The method of claim 11, wherein generating the plurality of top point sets from the ranked points in the multidimensional point cloud comprises generating a plurality of top point sets with increasing cardinality based on a base size of a first top point set of the plurality of top point sets.

13. The method of claim 12, wherein the increasing cardinality is based on exponential growth of the base size.

14. The method of claim 12, wherein a k^{th} point set from the plurality of top point sets comprises a subset of a k+1^{th} point set from the plurality of top point sets.

15. The method of claim 11, wherein retraining the neural network comprises calculating a noise contrastive estimation loss between the plurality of top point sets and a plurality of point sets from one or more other multidimensional point clouds.

16. A processing system, comprising:
a memory having executable instructions stored thereon; and
one or more processors configured to execute the executable instructions in order to cause the processing system to:
generate a score for each respective point in a multidimensional point cloud using a scoring neural network;
rank points in the multidimensional point cloud based on the generated score for each respective point in the multidimensional point cloud;
select top points from the ranked multidimensional point cloud; and
take one or more actions based on the selected top points.

17. The processing system of claim 16, wherein to generate the score for each point in the multidimensional point cloud, the one or more processors are configured to cause the processing system to:
map the multidimensional point cloud into a feature map representing the multidimensional point cloud using a feature extracting neural network; and
generate the score for each respective point in the multidimensional point cloud based on the feature map representing the multidimensional point cloud.

18. The processing system of claim 17, wherein the feature extracting neural network is configured to map the multidimensional point cloud into the feature map based on a self-supervised loss function trained to map points in a multidimensional space to points in a multidimensional feature space.

19. The processing system of claim 17, wherein the feature map comprises a map with dimensions of a number of points in the multidimensional point cloud by a number of feature dimensions into which the multidimensional point cloud is mapped.

20. The processing system of claim 17, wherein the score for each respective point in the multidimensional point cloud is generated based on a global feature representing the multidimensional point cloud and a sum of scores for the respective point in each feature dimension in the feature map.

21. The processing system of claim 16, wherein to rank the points in the multidimensional point cloud, the one or more processors are configured to cause the processing system to rank the points in the multidimensional point cloud based on an optimal transport problem between an unordered ranking of points in the multidimensional point cloud to an ordered ranking of points in the multidimensional point cloud.

22. The processing system of claim 16, wherein to select the top points from the ranked multidimensional point cloud, the one or more processors are configured to cause the processing system to select top k points based on noise contrastive estimation over a plurality of subsets of multidimensional point clouds.

23. The processing system of claim 16, wherein the one or more actions comprise classifying an input represented by the multidimensional point cloud as representative of one of a plurality of types of objects.

24. The processing system of claim 16, wherein the one or more actions comprise semantically segmenting an input image into a plurality of segments, each segment of the plurality of segments corresponding to a type of object in the input image.

25. The processing system of claim 16, wherein the multidimensional point cloud comprises a set of points having a plurality of spatial dimensions.

26. A processing system, comprising:
a memory having executable instructions stored thereon; and
one or more processors configured to execute the executable instructions in order to cause the processing system to:
train a neural network to map multidimensional point clouds into feature maps;
generate a score for each respective point in a multidimensional point cloud;
rank points in the multidimensional point cloud based on the generated score for each respective point in the multidimensional point cloud;
generate a plurality of top point sets from the ranked points in the multidimensional point cloud; and
retrain the neural network based on a noise contrastive estimation loss calculated based on the plurality of top point sets.

27. The processing system of claim 26, wherein to generate the plurality of top point sets from the ranked points in the multidimensional point cloud, the one or more processors are configured to cause the processing system to generate a plurality of top point sets with increasing cardinality based on a base size of a first top point set of the plurality of top point sets.

28. The processing system of claim 27, wherein the increasing cardinality is based on exponential growth of the base size.

29. The processing system of claim 27, wherein a k^{th} point set from the plurality of top point sets comprises a subset of a k+1^{th} point set from the plurality of top point sets.

30. The processing system of claim 26, wherein to retrain the neural network, the one or more processors are configured to cause the processing system to calculate a noise contrastive estimation loss between the plurality of top point sets and a plurality of point sets from one or more other multidimensional point clouds.
